(19) United States
(12) Patent Application Publication
(10) Pub. No.: US 2025/0251863 A1
(43) Pub. Date: Aug. 7, 2025

(54) STORAGE DEVICE, STORAGE SYSTEM INCLUDING THE SAME, AND METHOD OF OPERATING THE SAME

(71) Applicant: Samsung Electronics Co., Ltd., Suwon-si (KR)

(72) Inventors: Myungkyu Kim, Suwon-si (KR); Junyeong Seok, Suwon-si (KR)

(21) Appl. No.: 19/019,994

(22) Filed: Jan. 14, 2025

(30) Foreign Application Priority Data
Feb. 1, 2024 (KR) 10-2024-0016215

(51) Int. Cl. G06F 3/06

(52) U.S. Cl. CPC G06F 3/0613; G06F 3/0659; G06F 3/0679

(57) ABSTRACT

A storage device includes a nonvolatile memory including a plurality of planes, each including a plurality of pages, and a controller configured to control the nonvolatile memory. The controller may be configured to receive a plurality of commands from a host, merge a plurality of read commands, associated with at least two different planes among the plurality of planes and associated with at least two different pages among the plurality of pages, among the plurality of commands and transmit a merge command signal to the nonvolatile memory, and apply the merge command signal to the nonvolatile memory.

### CROSS-REFERENCE TO RELATED APPLICATION(S)

This U.S. non-provisional application claims priority under 35 USC § 119 to Korean Patent Application No. 10-2024-0016215, filed on Feb. 1, 2024, in the Korean Intellectual Property Office, the disclosure of which is herein incorporated by reference in its entirety.

### BACKGROUND

Example embodiments relate to a storage device, a storage system including the same, and a method of operating the same.

In general, semiconductor memory devices may be classified into volatile memory devices and nonvolatile memory devices. Volatile memory devices, such as a dynamic random access memory (DRAM) device and a static random access memory (SRAM) device, have high read and write speeds but lose their stored data when their power supplies are interrupted, while nonvolatile memory devices retain stored data even when the power supplies are interrupted.

With advancements in semiconductor technology, storage devices based on nonvolatile memory are being developed. In a semiconductor memory with a single-plane structure, memory operations are performed on only one block at a time. However, in a semiconductor memory with a multi-plane structure, memory operations may be performed simultaneously on adjacent blocks disposed in consecutive planes, resulting in improved performance. Accordingly, such a multi-plane structure is employed to improve the performance of semiconductor memory devices.

A plane independent read (PIR) function, allowing independent read operations for each plane, may be supported to perform a read operation on multiple planes. Currently, it may be difficult to selectively read a desired page for each plane, and only read operations of aligned pages for all planes may be performed. In addition, the PIR function may need a status check for each plane, which may lead to inefficiency in terms of input and output.

### SUMMARY

Example embodiments provide a storage device for performing a read operation on an unaligned page for each plane, a storage system including the same, and a method of operating the same.

According to example embodiments, a storage device includes a nonvolatile memory including a plurality of planes, each including a plurality of pages, and a controller configured to control the nonvolatile memory. The controller may be configured to receive a plurality of commands from a host, merge a plurality of read commands among the plurality of commands into a merge command signal. The plurality of read commands are associated with at least two different planes among the plurality of planes and are associated with at least two different pages among the plurality of pages, among the plurality of commands. The controller is further configured to transmit the a merge command signal to the nonvolatile memory, and apply a merge command signal to the nonvolatile memory.

According to example embodiments, a method of operating a controller includes receiving a plurality of commands from a host, merging a plurality of read commands among the plurality of commands into a merge command signal. The plurality of read commands are associated with at least two different planes among a plurality of planes. The plurality of planes each include a plurality of pages and are each associated with at least two different pages among the plurality of pages. The method includes transmitting the merge command signal to a nonvolatile memory.

According to example embodiments, a storage system includes a host, configured to apply a plurality of commands, and a storage device configured to receive the plurality of commands from the host, merge a plurality of read commands among the plurality of commands into a merge command signal. The plurality of read commands are associated with at least two different planes among a plurality of planes. The plurality of planes each include a plurality of pages and are each associated with at least two different pages among the plurality of pages. The storage device is further configured to perform a read operation based on the merge command signal.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a diagram of a storage device according to example embodiments.

FIG. 2 is a diagram illustrating an example of a nonvolatile memory illustrated in FIG. 1.

FIG. 3 is a diagram illustrating a controller according to example embodiments.

FIG. 4 is a diagram illustrating a queuing operation of a controller according to example embodiments.

FIG. 5 is a diagram illustrating a speed queuing operation of a controller according to example embodiments.

FIG. 6 is a diagram illustrating planes that are read targets according to example embodiments.

FIG. 7 is a diagram illustrating a storage device according to example embodiments.

FIG. 8 is a diagram illustrating a read operation and a status check operation according to example embodiments.

FIG. 9 is a diagram illustrating an example of a memory block including a memory cell array according to example embodiments.

FIG. 10 is a diagram illustrating a read operation by page type according to example embodiments.

FIG. 11 is a diagram illustrating a read operation according to example embodiments.

FIG. 12 is a diagram illustrating a read voltage level adjustment operation according to example embodiments.

FIG. 13 is a diagram illustrating a read voltage level adjustment operation according to example embodiments.

FIG. 14 is a flowchart illustrating a method of operating a controller according to example embodiments.

FIG. 15 is a flowchart illustrating a command merging operation method for the same type pages according to example embodiments.

FIG. 16 is a diagram a flowchart illustrating a command processing operation method of a controller according to example embodiments.

FIG. 17 is a flowchart illustrating a command processing operation method of a controller according to example embodiments.

FIG. 18 is a diagram illustrating a storage system according to example embodiments.

### DETAILED DESCRIPTION

Hereinafter, example embodiments will be described with reference to the accompanying drawings.

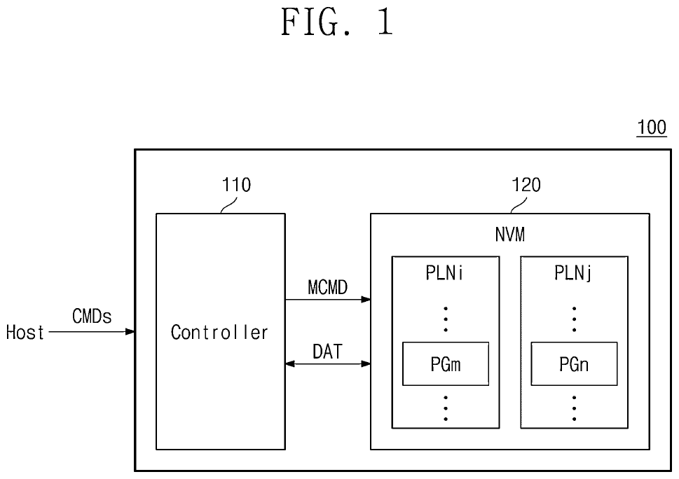

FIG. 1 is a diagram of a storage device according to example embodiments.

Referring to FIG. 1, a storage device 100 according to example embodiments may include a controller 110 and a nonvolatile memory 120. The storage device 100 may store data DAT in the nonvolatile memory 120 under the control of the controller 110. For example, each of the controller 110 and the nonvolatile memory 120 may be provided in a single chip, a single package, or a single module. According to some embodiments, the controller 110 and the nonvolatile memory 120 may be formed into a single chip, a single package, or a single module and provided as a storage such as an embedded memory, a memory card, a memory stick, or a solid-state drive (SSD).

The controller 110 may control the nonvolatile memory 120. For example, the controller 110 may be implemented in hardware (for example, logic circuitry), software, firmware, or a combination of hardware, software, and firmware. Examples of logic circuitry include dedicated hardwired logic circuitry (for example, one or more state machine logic circuits), programmable logic circuitry (for example, field programmable gate array (FPGA), or a programmable logic array (PLA). For example, the logic circuitry may be designed to execute program code such as SSD firmware (for example, embedded processors, embedded controllers, or the like). The controller 110 may perform an access operation to program write data DAT in the nonvolatile memory 120 or to read data DAT stored in the nonvolatile memory 120 according to a request from a host. The controller 110 may generate, process, and manage a command, an address, and a control signal for accessing the nonvolatile memory 120.

The nonvolatile memory 120 may include a plurality of planes (which may also be referred to as mats). Each of the plurality of planes may include a plurality of memory blocks. For example, each of the plurality of memory blocks may have a vertical 3D structure. Each of the plurality of memory blocks may include a plurality of pages, and each of the plurality of pages may include a plurality of memory cells. Each memory block may be an erase unit, and each page may be a program or read unit. Each memory cell may store multi-bit data. For example, a memory cell may include a single-level cell (SLC) storing 1 bit of data, a multi-level cell (MLC) storing 2 bits of data, a triple-level cell (TLC) storing 3 bits of data, a quadruple-level cell (QLC) storing 4 bits of data, or cells storing more bits of data.

For ease of description, FIG. 1 illustrates an i-th plane PLNi (where i is a positive integer) and a j-th plane PLNj (where j is a positive integer different from i), but example embodiments are not limited thereto.

According to example embodiments, the controller 110 may merge read commands for unaligned pages with respect to a plurality of planes included in the nonvolatile memory 120. The term “unaligned pages for each plane” may refer to pages having different indices of the page requested for access on a plurality of planes. For example, an m-th page PGm and an n-th plane (where m and n are positive integers different from each other) illustrated in FIG. 1 may be regarded as unaligned pages for each plane with respect to the i-th plane PLNi and the j-th plane PLNj.

The controller 110 may receive a plurality of commands CMDs for the plurality of planes. The plurality of commands CMDs may be commands instructing access operations, such as program, read, and erase operations, to the nonvolatile memory 120 of the controller 110. Program commands and read commands may instruct program and read operations on pages included in each plane.

The controller 110 may select read commands for unaligned pages for each plane from among the received plurality of commands CMDs and merge the selected read commands. For example, the controller 110 may merge a plurality of read commands associated with at least two different pages, among the received plurality of commands CMDs. For example, the controller 110 may select a read command for an m-th page PGm included in an i-th plane PLNi and a read command for an n-th page PGn included in a j-th plane PLNj from commands, and may merge the selected read commands to generate a merge command signal MCMD.

The merge command signal MCMD generated by the controller 110 may be defined as a command signal for instructing the nonvolatile memory 120 to sequentially perform read operations on different pages of different planes. The merge command signal MCMD may be defined as a signal that encompasses all or many elements, including a command (for example, a read command), an address at which the command is to be executed, and various control signals for executing the command.

The controller 110 may invoke (or transmit or issue) the generated merge command signal MCMD to the nonvolatile memory 120. According to example embodiments, when a read operation is performed on different planes and pages based on the merge command signal MCMD, input/output (I/O) efficiency may be improved and power consumption may be reduced compared to plane independent read (PIR) in which a read command should be invoked for each plane. In the case of PIR, the controller 110 invokes a unit command for a single plane and a single page as many times as the number of unaligned pages for each plane on which a read operation is to be performed. In addition, a status check command for checking status information of the plane after the read operation is completed should also be performed as many times as the number of unaligned pages for each plane. In example embodiments, the controller 110 merges read commands for unaligned pages for each plane and invokes the merge command signal MCMD, so that the number of times the command is invoked and the number of times the status check is performed may be reduced. In addition, power consumption may also be reduced compared to PIR in the case of merging read commands.

In addition, when a read operation may be performed on unaligned pages for each plane through the controller 110 according to example embodiments, different blocks may be simultaneously processed even when the storage device 100 performs garbage collection.

The nonvolatile memory 120 may perform a read operation on different pages of different planes (for example, unaligned pages for each plane) when receiving the merge command signal MCMD from the controller 110. The nonvolatile memory 120 may read data DAT stored in each of the different pages of different planes and transmit the read data DAT to the controller 110.

The storage device 100 according to the above-described embodiments may improve I/O efficiency and reduce power consumption, compared to PIR, by merging read commands for unaligned pages for each plane and invoking a merge command signal MCMD to the nonvolatile memory 120.

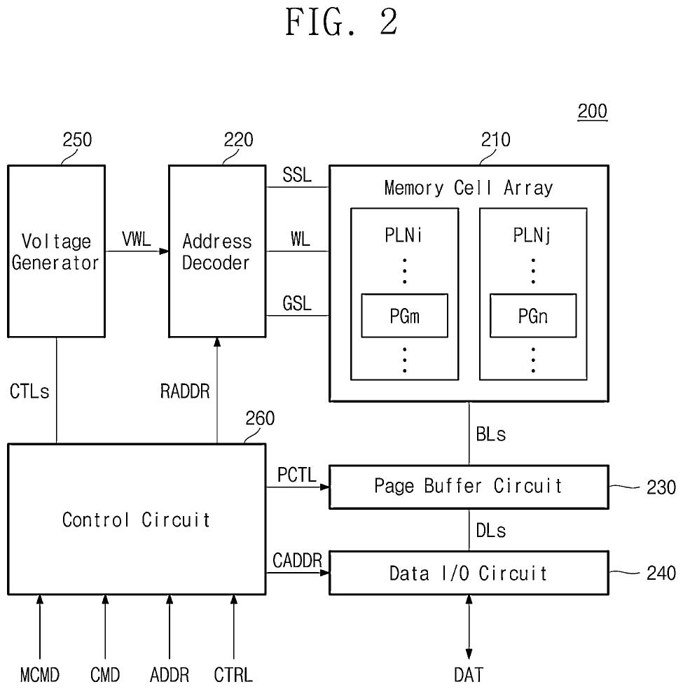

FIG. 2 is a diagram illustrating an example of a nonvolatile memory illustrated in FIG. 1.

Referring to FIG. 2, the nonvolatile memory 200 according to example embodiments may include a memory cell array 210, an address decoder 220, a page buffer circuit 230, a data input/output (I/O) circuit 240, a voltage generator 250, and a control circuit 260.

The memory cell array 210 may be connected to the address decoder 220 through a string select line SSL, a plurality of wordlines WLs, and a ground select line GSL. The memory cell array 210 may be connected to the page buffer circuit 230 through a plurality of bitlines BLs.

The memory cell array 210 may include a plurality of planes, and each of the plurality of planes may include a plurality of nonvolatile memory cells connected to the plurality of wordlines WLs and the plurality of bitlines BLs. The nonvolatile memory cells connected to each of the plurality of wordline may be a page. Therefore, each of the plurality of planes may include a plurality of pages.

According to example embodiments, the memory cell array 210 may be a three-dimensional memory cell array 210 formed in a three-dimensional structure (or a vertical structure) on a substrate. In example embodiments, the memory cell array 210 may include vertical memory cell strings including a plurality of stacked memory cells.

The address decoder 220 may be connected to the memory cell array 210 through a string select line SSL, a plurality of wordlines WLs, and a ground select line GSL. During a program operation or a read operation, the address decoder 220 may determine one of the plurality of wordlines WLs as a selected wordline based on a row address RADDR provided by the control circuit 260, and determine the remaining wordlines WLs from among the plurality of wordlines WLs as unselected wordlines.

The page buffer circuit 230 may be connected to the memory cell array 210 through a plurality of bitlines BLs. The page buffer circuit 230 may include a plurality of page buffers. The page buffer circuit 230 may temporarily store data to be programmed in a selected page during a program operation, and may temporarily store data read from the selected page during a read operation.

The data input/output circuit 240 may be connected to the page buffer circuit 230 through a plurality of data lines DLs. During a program operation, the data input/output circuit 240 may receive program data DAT from the controller described above in FIG. 1, and provide the program data DAT to the page buffer circuit 230 based on the column address CADDR provided by the control circuit 260. During a read operation, the data input/output circuit 240 may provide read data DAT, stored in the page buffer circuit 230, to the controller based on the column address CADDR provided by the control circuit 260.

The voltage generator 250 may generate wordline voltages VWLs required for the operation of the nonvolatile memory 200 based on control signals CTLs provided by the control circuit 260. The wordline voltages VWLs generated by the voltage generator 250 may be applied to the plurality of wordlines WLs through the address decoder 220.

The control circuit 260 may control various operations of the nonvolatile memory 200. The control circuit 260 may receive a command signal CMD, a control signal CTRL, and an address signal ADDR from the controller, and may perform a program operation, a read operation, an erase operation, or the like, on the nonvolatile memory 200 based on the command signal CMD, the control signals CTRL, and the address signal ADDR. For example, the control circuit 260 may generate control signals CTLs to control the voltage generator 250 based on the command signal CMD, page buffer control signals PCTL to control the page buffer circuit 230, and may generate a row address RADDR and a column address CADDR based on the address signal ADDR. The control circuit 260 may provide the row address RADDR to the address decoder 220 and the column address CADDR to the data input/output circuit 240.

According to example embodiments, the control circuit 260 may receive a merge command signal MCMD from the controller and perform read operations on different pages of different planes based on the merge command signal MCMD. For example, the control circuit 260 may generate control signals CTLs to select a wordline corresponding to an m-th page PGm of an i-th plane PLNi and an n-th page PGn of the j-th plane PLNj based on the merge command signal MCMD and transmit the selected wordline to the voltage generator 250. In addition, the control circuit 260 may generate a row address RADDR and a column address CADDR, respectively corresponding to the m-th page PGm of the i-th plane PLNi and the n-th page PGn of the j-th plane PLNj, based on address information of the merge command signal MCMD and transmit the generated row address RADDR and column address CADDR to the address decoder 220 and the data input/output circuit 240.

According to example embodiments, the nonvolatile memory 200 may perform a set-up on at least two different pages based on receiving the merge command signal MCMD. For example, the set-up may include a power-on/off operation, a ready-and-busy (RnB) operation, or the like, on a page buffer for each plane. When receiving the merge command signal MCMD, the control circuit 260 may perform a set-up once for a read operation for unaligned pages for each plane. Since the set-up is performed on all planes associated with the unaligned pages for each plane, operations that may be commonly performed on all planes, among the operations included in the set-up, may be performed once. In contrast, in the case of PIR, the nonvolatile memory 200 should perform the set-up individually whenever receiving a unit command for each plane. Accordingly, the nonvolatile memory 200 according to example embodiments may more efficiently perform the set-up for the read operation based on the merge command signal MCMD than PIR.

Among the circuits that operate for the set-up operation, circuits common to the planes may also perform the set-up even with one operation, compared to PIR. Accordingly, the nonvolatile memory 200 according to example embodiments may reduce power consumption compared to PIR.

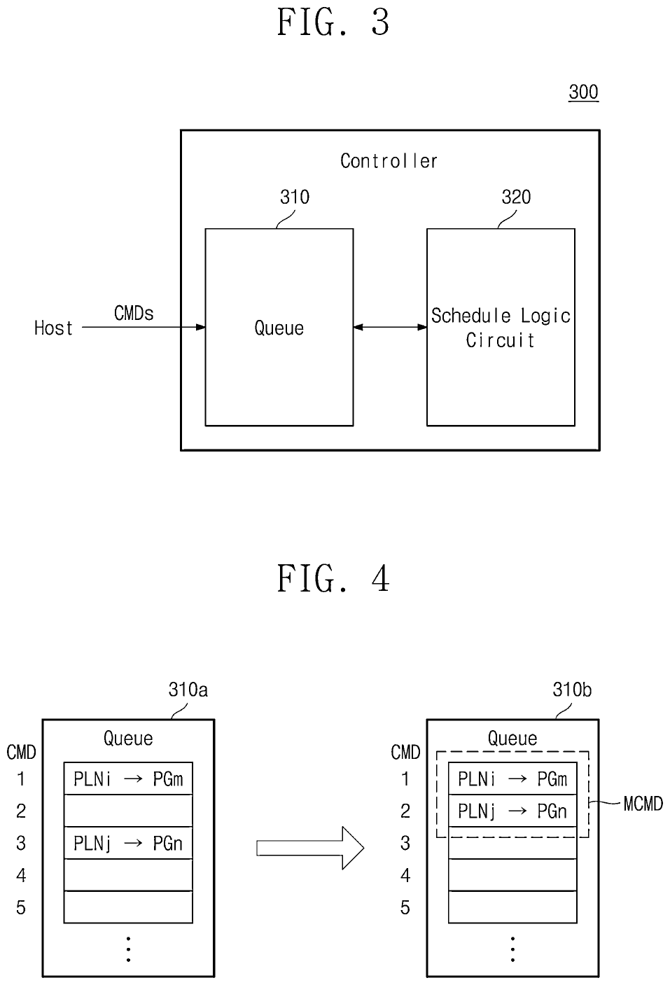

FIG. 3 is a diagram illustrating a controller according to example embodiments.

Referring to FIG. 3, a controller 300 according to example embodiments, may include a queue 310 and a schedule logic circuit 320. The controller 300 may store a plurality of commands CMDs, received from a host, in the queue 310.

The queue 310 may store a plurality of commands CMDs and may be implemented in the controller 300 to generate a merge command signal according to the above-described embodiments. For example, the queue 310 may be implemented using hardware, software, firmware, or a combination of hardware, software, and/or firmware. For example, the queue 310 may be implemented using a first-in-first-out (FIFO) memory or data structures of firmware or software (for example, an array, a linked list, or other data structures). The queue 310 may include x entries (where x is a positive integer) to accept a plurality of commands CMDs received from a host. A single command, requesting an access to a single plane and a single page, may be stored in a single entry.

The schedule logic circuit 320 may be configured to select a plurality of read commands from within the queue 310 and to sequentially merge the plurality of read commands. For example, the schedule logic circuit 320 may select a plurality of read commands from within the queue 310 requesting read operations on different planes and different pages, and may merge the read commands such that the selected read commands are disposed (or stored) in consecutive entries. Accordingly, the schedule logic circuit 320 may allow the nonvolatile memory to simultaneously read addresses for different pages of different planes through command merging.

The merged merge command signal within the queue 310 may be invoked to the nonvolatile memory through the controller 300 at one timing at a time. In the case of PIR, a single command should be separately invoked at each timing, so that a plurality of commands CMDs for unaligned pages for each plane may be invoked at the same timing or different timings in terms of an invoking operation. Accordingly, within the queue 310, when one command is invoked, the other commands should wait for the order in which they are invoked. In example embodiments, within the queue 310, read commands for unaligned pages for each plane may be merged into a single merge command signal through the schedule logic circuit 320 to read the unaligned pages for each plane with only one invoking operation at one timing.

FIG. 4 is a diagram illustrating a queuing operation of a controller according to example embodiments.

Referring to FIG. 4, a controller according to example embodiments may sequentially store a plurality of commands, received from a host, in a queue. For example, commands may be stored in a queue 310a in the order of a first command CMD1 requesting a read operation for an m-th page PGm of an i-th plane PLNi, a second command CMD2, a third command CMD3 requesting a read operation for an n-th page PGn of a j-th plane PLNj, a fourth command CMD4, and a fifth command CMD5.

When a read operation for unaligned pages for each plane is required, the controller may merge read commands (the first command CMD1 and the third command CMD3) for the unaligned pages for each plane within a queue through the schedule logic circuit to generate a merge command signal MCMD. As a result, the first command CMD1 and the third command CMD3 may be disposed (or stored) in consecutive entries within the queue 310b, and the controller may then perform a sequential read operation on the nonvolatile memory based on the first command CMD1 and the third command CMD3. For example, the controller may invoke the merge command signal MCMD to the queue at one timing at a time.

In the case of PIR, instead of invoking a single merge command signal (MCMD) unit as described in example embodiments, individual read commands should be invoked for the number of planes to be read, and a corresponding status check should also be performed the same number of times. According to example embodiments, only one invoking operation and only one status check may be performed by merging read commands for unaligned pages for each plane of different planes through a controller, so that input/output efficiency may be improved and power consumption may be reduced.

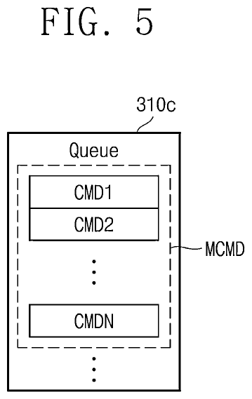

FIG. 5 is a diagram illustrating a speed queuing operation of a controller according to example embodiments.

Referring to FIG. 5, a controller according to example embodiments may determine the number of unit commands to be merged depending on speed mode. Hereinafter, the term “unit command” may refer to a read command for a single plane. The controller may perform a read operation on a plurality of planes in speed mode. For example, the controller may perform a read operation on N planes in nX speed mode (where N is a positive integer and the number of planes). In speed mode, the controller may perform a read operation on N planes. In speed mode, the controller may determine N that is the number of planes on which a read operation is to be performed. When the controller determines N that is the number of planes, it is regarded as determining the number of unaligned pages for each plane (for example, at least two different pages) that is to be a target of the merge command signal MCMD.

According to example embodiments, the controller may merge read commands for N unaligned pages of N different planes in speed mode to generate a merge command signal MCMD. For example, the controller may select read commands (for example, first command to N-th command CMD1 to CMDN) for N planes according to speed mode from a plurality of commands stored in the queue 310c, and may merge the selected read commands.

As a result, the storage device according to the above-described embodiments may merge unit commands corresponding to the number of planes requested to be read in speed mode for unaligned pages for each plane.

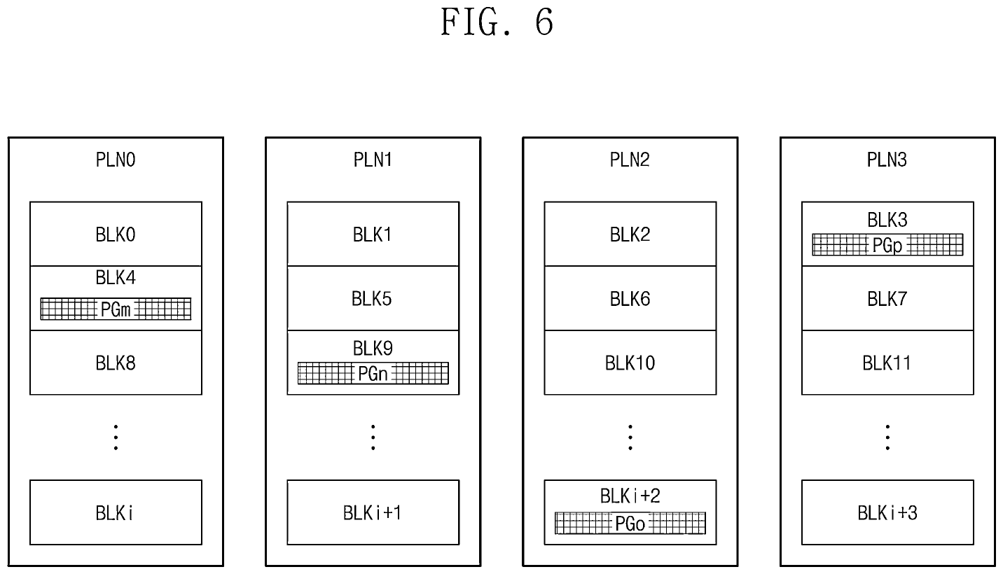

FIG. 6 is a diagram illustrating planes that are read targets according to example embodiments.

Referring to FIG. 6, for example, first to fourth planes PLN0 to PLN3 are different from each other and may be targets of read commands. Each plane may include a plurality of different blocks. Blocks may be included in any one plane. Each block may include a plurality of pages.

An example is provided in which a controller receives a first read command for a first page PGm of a fifth block BLK4 of the first plane PLN0, a second read command for a second page PGn of a tenth block BLK9 of the second plane PLN1, a third read command for a third page PGo of an i+2-th block BLKi+2 of the third plane PLN2, and a fourth read command for a fourth page PGp of a fourth block BLK3 of the fourth plane PLN3, from a host. In the above example, target pages of a read operation may have different indices for each plane. For example, a read request for unaligned pages for each plane for different planes may be made from the host.

The controller may merge corresponding read commands according to the above-described embodiments to generate a merge command signal. The controller may perform a sequential read operation on unaligned pages (first to fourth pages) for each illustrated plane by invoking a merge command signal of one timing (i.e., where the timing of the various signals are aligned in time or based on a common timing reference). As a result, the storage device according to example embodiments may perform a sequential read operation on different pages of different planes through read command merging and invoking operations of the controller.

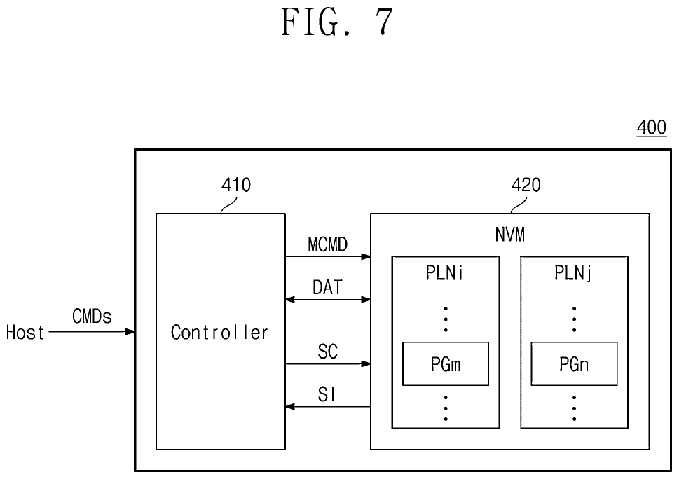

FIG. 7 is a diagram illustrating a storage device according to example embodiments.

Referring to FIG. 7, a storage device 400 according to example embodiments may merge read commands for unaligned pages (for example, an m-th page PGm and an n-th page PGn) for each plane from among a plurality of commands CMDs received from a host according to the above-described embodiments, and may invoke a merge command signal MCMD to a nonvolatile memory 420. The nonvolatile memory 420 may read data DAT from unaligned pages for each plane for a plurality of planes (for example, an i-th plane PLNi and a j-th plane PLNj) and transmit the read data DAT to a controller 410.

The controller 410 may invoke a status check command SC to the nonvolatile memory 420 to check a status of the nonvolatile memory 420. The nonvolatile memory 420 may transmit status information SI to the controller 410 in response to the status check command SC. For example, the status information SI may be status information SI on a plane of the nonvolatile memory 420 and may include read pass/fail information, program pass/fail information, ready/busy information, or the like.

According to example embodiments, the controller 410 may invoke a merge command signal MCMD to the nonvolatile memory 420 and invoke a status check command SC to the nonvolatile memory 420. In example embodiments, the controller 410 may invoke only one status check command SC to planes associated with unaligned pages for each plane, rather than invoking a status check command SC to each plane. For example, the controller 410 may transmit the merge command signal MCMD and then invoke a single status check command SC for at least two different planes, including at least two different pages, to the nonvolatile memory 420. Since the controller 410 merged unit commands for unaligned pages for each plane into a merge command signal MCMD and invoked the merge command signal MCMD at one timing, the controller 410 may not invoke a status check command SC to each plane. The invoked status check command SC may be defined as a command requesting a status check for at least two different planes, rather than a command requesting a status check for a single plane.

In the case of PIR, a plurality of single commands are invoked to each plane, so that a status check operation should be performed on each plane. For example, in PIR, the number of times the status check command SC is invoked may be the same as the number of planes. Each time the status check command SC is invoked, a data line between the controller 410 and the nonvolatile memory 420 is used and other signals should wait during that time.

According to the above-described embodiments, the storage device 400 may improve input/output efficiency and reduce power consumption by performing a read operation on planes including unaligned pages for each plane and then invoking only one status check command SC, rather than invoking a status check command SC to each plane.

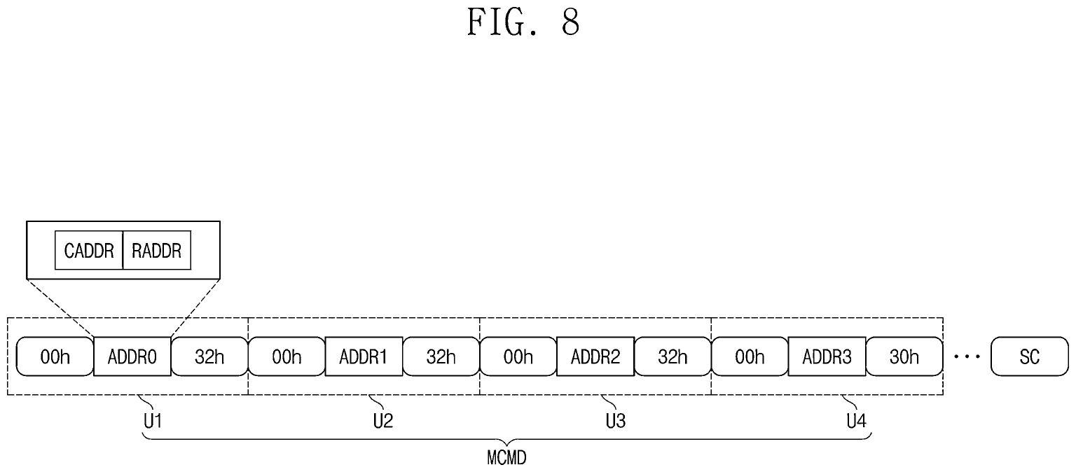

FIG. 8 is a diagram illustrating a read operation and a status check operation according to example embodiments.

Referring to FIG. 8, the controller may merge unit commands U1 to U4 to generate a merge command signal MCMD. Each unit may have an address, different from that of a read command (for example, 00 h or 32 h), and each address may include a column address CADDR and a row address RADDR in a nonvolatile memory to represent different planes and different pages.

A length of the merge command signal MCMD on a time domain may be the same as the sum of lengths of unit commands, but each of the unit commands may be invoked once, rather than N times, in terms of a command invoking operation. A last unit command of the merge command signal MCMD may include a command (for example, 30 h) to initiate an access to the nonvolatile memory and a read operation on the nonvolatile memory.

After invoking the merge command signal MCMD, the controller may invoke a single status check command SC to planes (and at least two different pages). In example embodiments, the invoked status check command SC may be a command for checking status information of all planes associated with the merge command signal MCMD invoked before the status check command SC, rather than a command for checking status information for each plane. In the case of PIR, a unit command for each plane is invoked N times at different timings, so that state information of all planes is unable to be checked through status check even when the status check command is invoked together with a single unit command.

The storage device according to example embodiments performs read operations simultaneously on all planes by invoking the merge command signal MCMD at one timing, so that status information of all planes may be checked by invoking only one status check command SC. As a result, the storage device according to example embodiments may invoke only one status check command SC, rather than N status check commands SC, to improve input/output efficiency and reduce power consumption.

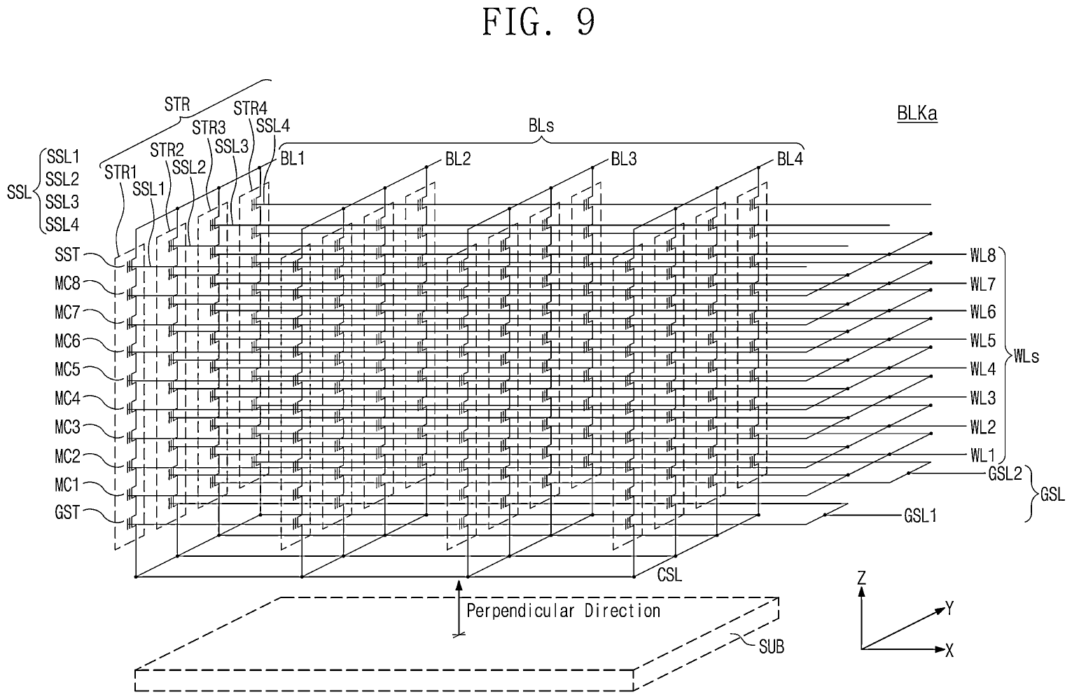

FIG. 9 is a diagram illustrating an example of a memory block with a memory cell array according to example embodiments.

Referring to FIG. 9, a plurality of strings STR may be disposed in rows and columns on a substrate SUB. The plurality of strings STR may be commonly connected to a common source line CSL formed on (or in) the substrate SUB. In FIG. 9, the location of the substrate SUB is illustrated as an example to better understood the structure of a memory block BLKa.

In FIG. 9, a common source line CSL is illustrated as being connected to a lower end of the strings STR. However, the common source line CSL may be any string as long as it is electrically connected to lower ends of the strings STR and is not limited to being physically located on the lower end of the strings STR. For example, in FIG. 9, the strings STR are illustrated as being arranged in a 4×4 array, but the memory block BLKa may include a smaller or larger number of strings.

Strings STR of each row may be commonly connected to a ground select line GSL1 or GSL2. For example, strings STR1 and STR2 of first and second rows may be commonly connected to a first ground select line GSL1, and strings STR3 and STR4 of third and fourth rows may be commonly connected to a second ground select line GSL2. However, this is only an example, and four different ground select lines may be provided, and the strings STR of each row may be implemented to be connected to different ground select lines.

The strings STR of each row may be connected to corresponding string select lines, among first, second, third, and fourth string select lines SSL1, SSL2, SSL3, and SSL4. A cell string STR of each column may be connected to a corresponding bitline, among first, second, third, and fourth bitlines BL1, BL2, BL3, and BL4.

Each string may include at least one ground select transistor GST connected to the ground select line GSL1 or GSL2, a plurality of memory cells MC1 to MC8, respectively connected to a plurality of wordlines WL1 to WL8, and string select transistors SST, respectively connected to string select lines SSL1, SSL2, SSL3, and SSL4.

In each string, a ground select transistor GST, memory cells MC1 to MC8, and string select transistors SST may be connected in series in a direction perpendicular to the substrate SUB, and may be sequentially stacked in the direction perpendicular to the substrate SUB. In each string STR, at least one of the memory cells MC1 to MC8 may be used as a dummy memory cell. The dummy memory cell may not be programmed (for example, program-inhibited) or may be programmed in a different manner from the memory cells MC1 to MC8.

The circuit structure of the memory cells included in a memory block BLK has been described in brief. However, the illustrated circuit structure of the memory block is a simplified structure for ease of description, and an actual memory block is not limited to the illustrated example. For example, it will be understood that a single physical block may include more semiconductor layers, bitlines BLs, and string select lines SSLs.

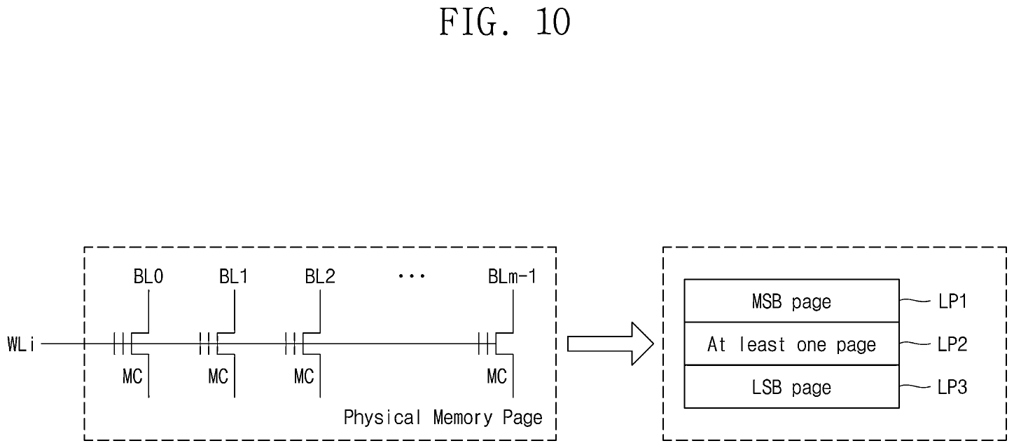

FIG. 10 is a diagram illustrating a read operation by page type according to example embodiments.

Referring to FIG. 10, according to the above-described embodiments, a plurality of memory cells MC may be connected to an i-th wordline WLi (for example, one of the wordlines of FIG. 9). Each wordline and memory cells MC may correspond to a physical page. For example, a physical page of FIG. 10 may include memory cells MC arranged in a region in which a single wordline WLi and a plurality of bitlines BL0 to BLm-1 intersect each other.

Each of the memory cells MC may be a multi-level cell storing two or more bits of data. For example, when memory cells MC included in a physical page are multi-level cells storing 2 bits of data, each of the memory cells MC may store least significant bit (LSB) data and most significant bit (MSB) data. In example embodiments, the physical page may include two logical pages, a first logical page LP1 and second logical page LP2. For example, when the memory cells MC included in a physical page are triple-level cells TLC storing 3 bits of data, each of the memory cells MC may store least significant bit (LSB) data, central significant bit (CSB) data, and most significant bit (MSB) data. In example embodiments, the physical page may include three logical pages, a first logical page LP1 (for example, a logical page corresponding to MSB data), a second logical page LP2, and a third logical page LP3 (for example, a logical page corresponding to LSB data). For example, when the memory cells MC included in a physical page are cells storing 4 or more bits of data, one or more intermediate bits of data may be stored in each memory cell depending on additional bits.

In summary, each of a plurality of pages may be classified as one of a plurality of logical pages corresponding to k-bits (where k is a positive integer greater than or equal to 2) that may be represented by a single cell. A single cell may have a threshold voltage distribution, represented by a set of a plurality of threshold voltages, depending on a size of k and an erase state and a plurality of program states programmed in a single cell. Accordingly, logical pages exhibit different read speeds depending on the threshold voltage. For example, a logical page requiring a larger number of read voltages for a read operation may exhibit a lower read speed, and a logical page requiring a smaller number of read voltages for a read operation may exhibit a higher read speed. In addition, even when the same number of times of read voltage are required, the read speed may vary depending on the magnitude of the read voltage.

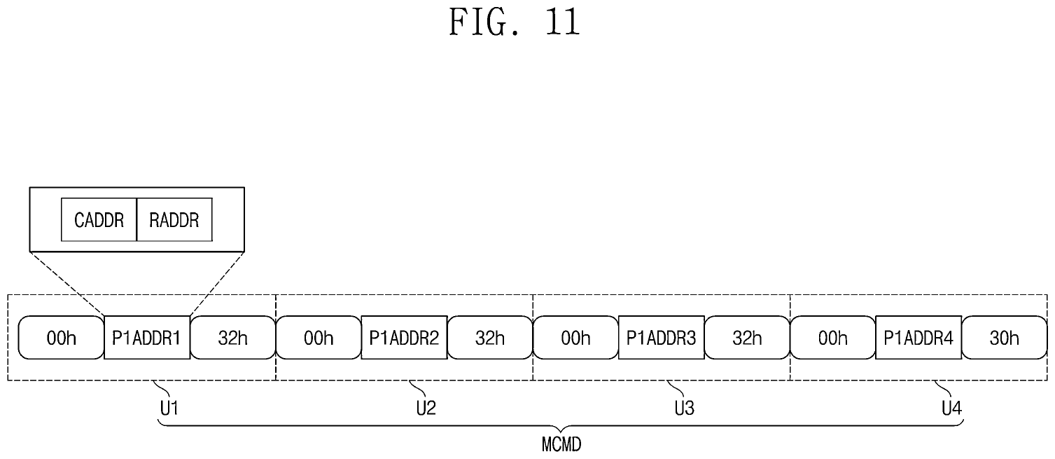

FIG. 11 is a diagram illustrating a read operation according to example embodiments.

Referring to FIG. 11, the controller according to example embodiments may take the type of logical pages described above in FIG. 10 into consideration when merging unit commands U1 to U4 for unaligned pages for each plane. For example, the controller may merge a plurality of read commands into units of a plurality of logical pages. As described in FIG. 10, logical pages may exhibit different read speeds depending on the type. Accordingly, when a read operation is performed without considering the type of logical page, a speed of the read operation on a plurality of planes and pages is inevitably constrained by the logical page having a relatively low read speed.

Considering that the read speed varies depending on a logical page, the controller may merge a plurality of read commands into units of only the same logical pages among a plurality of logical pages. For example, as illustrated in the drawing, the controller may merge unit commands requesting a read operation for an arbitrary first logical page to generate a merge command signal MCMD. Accordingly, addresses P1ADD1, P1ADD2, P1ADD3, and P1ADD4 of respective merge unit commands may all represent the same type of logical page (for example, first logical page). The addresses P1ADD1, P1ADD2, P1ADD3, and P1ADD4 of the respective unit commands may only have the same type of logical page, but may represent different unaligned pages for each plane (for example, different physical pages).

The nonvolatile memory, receiving a corresponding merge command signal MCMD from the controller, may perform a sequential read operation on the same type of logical pages. Since the logical pages have the same type, the nonvolatile memory may perform a read operation on unaligned pages for each plane without loss of read speed.

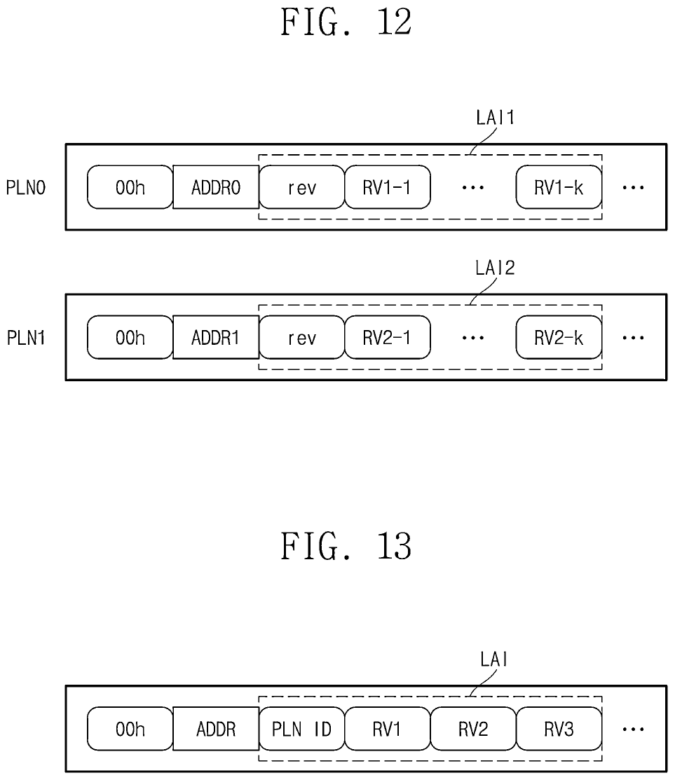

FIG. 12 is a diagram illustrating a read voltage level adjustment operation according to example embodiments.

Referring to FIG. 12, the controller according to example embodiments may adjust a read voltage level for a read operation for each plane. The read voltage level may refer to the level of a voltage applied to each memory cell for reading, depending on the number of multiple bits that a single cell is able to represent. The number, magnitude, or the like, of the read voltage levels may be set depending on whether a single memory cell is the above-described SLC, MLC, TLC, or QLC.

According to example embodiments, a unit command may be provided as illustrated to adjust the read voltage level of the controller. The unit command may be a command for a single plane, and may be received from the host by the controller. The unit command may commonly include a read command (for example, 00 h) and an address for each plane (for example, ADDR0 or ADDR1), and may additionally include level adjustment information LAI1 and LAI2 to adjust a read voltage level or read voltage for a read operation for each of the plurality of plane.

According to example embodiments, the level adjustment information LAI1 and LAI2 may include a reservation field rev and a plurality of pieces of voltage adjustment data. According to example embodiments, the reservation field rev may be omitted. The number and magnitude of the plurality of pieces of voltage adjustment data may be set depending on the type of memory cell.

According to example embodiments, the number of plurality of voltage adjustment data may be set depending on the number of logical pages of the memory cell. For example, when a memory cell that is a target of a command for each plane is TLC, the number of plurality of pieces of voltage adjustment data may be 3 that is the number of logical pages of TLC. Then, in the case of FIG. 12, k=3, and RV1-1, RV1-2, and RV1-3 may each be voltage adjustment data to adjust a read voltage level or read voltage for a different logical page, among logical pages (for example, LSB, CSB, and MSB) included in a first plane. In addition, RV2-1, RV2-2, and RV2-3 may each be voltage adjustment data to adjust a read voltage level for a different logical page, among logical pages included in a second plane.

The controller may invoke each unit command, including voltage adjustment data, to a nonvolatile memory. According to the above-described embodiments, a unit command invoked to each plane may include voltage adjustment data for each plane. Accordingly, the storage device according to example embodiments may adjust a read voltage level for reading multi-bit data for each plane and for unaligned pages for each plane.

FIG. 13 is a diagram illustrating a read voltage level adjustment operation according to example embodiments.

Referring to FIG. 13, a unit command according to example embodiments may be configured such that a reservation field according to FIG. 12 includes plane information PLN ID for which a read voltage level is to be adjusted. For example, the level adjustment information LAI may additionally include plane information PLN ID. The plane information PLN ID may be defined as information to identify a plane for which the read voltage level is to be adjusted based on the voltage adjustment data RV1 to RV3. Compared to FIG. 12, the controller may notify the nonvolatile memory of the plane to which the voltage adjustment data RV1 to RV3 is to be applied through the plane information PLN ID, without generating the voltage adjustment data RV1 to RV3 to be different for each plane.

The controller may merge unit commands, including level adjustment information LAI including plane information PLN ID for which a read voltage level is to be adjusted, to generate and invoke a merge command signal. Through the plane information PLN ID, each plane may receive the voltage adjustment data RV1 to RV3 from the controller without being affected by another plane.

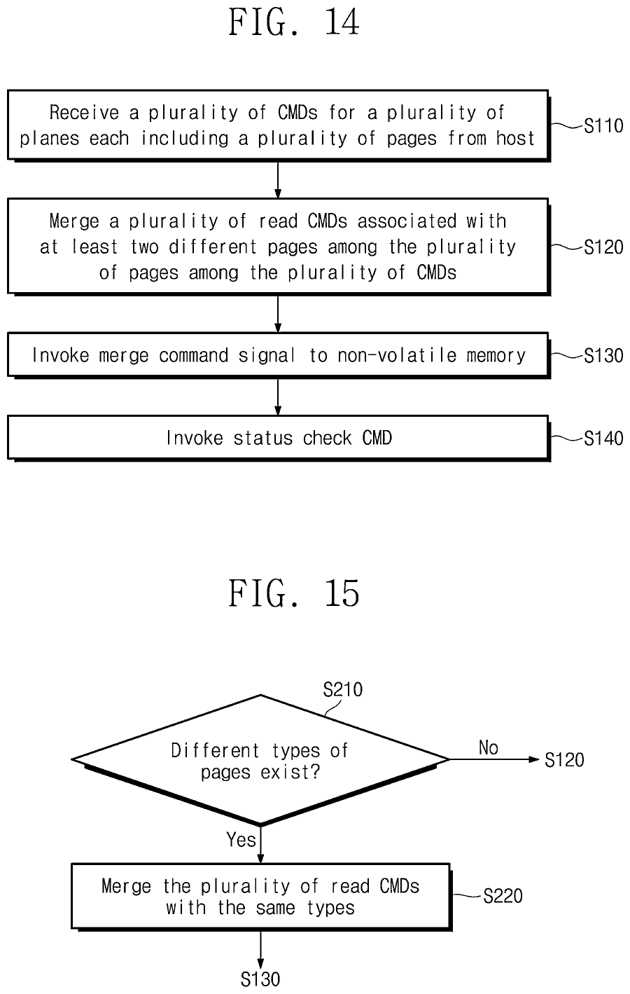

FIG. 14 is a flowchart illustrating a method of operating a controller according to example embodiments.

Referring to FIG. 14, in operation S110, the controller may receive a plurality of commands for a plurality of planes, each including a plurality of pages, from a host. The plurality of commands received from the host may be commands to request various accesses (for example, program, read, erase, or the like) to the nonvolatile memory.

In operation S120, the controller may merge a plurality of read commands, associated with at least two pages among the plurality of pages (for example, unaligned pages for each plane), among the plurality of commands received from the host. The merging operation may lead to generation of a merge command signal in which unit commands (for example, read commands) for each plane are sequentially merged. In example embodiments, a merge command may be constructed such that a command for initiating a read operation is disposed in the last unit command.

In operation S130, the controller may invoke or transmit the merge command signal to the nonvolatile memory. The merge command signal is a merged sequence of unit commands for multiple planes, and the command for initiating reading is located in the last unit command. The controller may invoke the merge command signal to the nonvolatile memory in one timing, and the nonvolatile memory may perform read operations for unaligned pages for each plane simultaneously when it receives the merge command signal.

In operation S140, the controller may invoke a single status check command to the nonvolatile memory for at least two different planes including at least two different pages. A merged command, in which a plurality of unit commands are merged, has been invoked through operation S130, so that the controller may check statuses of all planes even when invoking only one status check command. Therefore, according to the above-described operation method, the input/output efficiency of command invocation for unaligned pages for each plane may be increased and power consumption may be reduced.

FIG. 15 is a flowchart illustrating a command merging operation method for the same type pages according to example embodiments.

Referring to FIG. 15, in operation S210, the controller may determine whether there are different types of pages among a plurality of read commands to be merged. The term “type” may refer to the type of logical page for a single memory cell. For example, the controller may determine whether the plurality of read commands are for different types of pages. For example, when a read command for a first logical page and a read command for a second logical page are mixed, the controller may determine that there are different types of pages.

When it is determined that there are different types of pages in operation S210, the flow proceeds to operation S220 in which the controller may merge the plurality of read commands into the same logical page among the plurality of logical pages. For example, a single merge command signal may be a signal in which unit commands for the same logical page are merged. The controller may invoke the merge command signal to the nonvolatile memory operation (S130) to process a read operation for a page having the same read speed.

According to some embodiments, when all pages are of the same type, the controller may also merge unit commands for pages of the same type (operation S120).

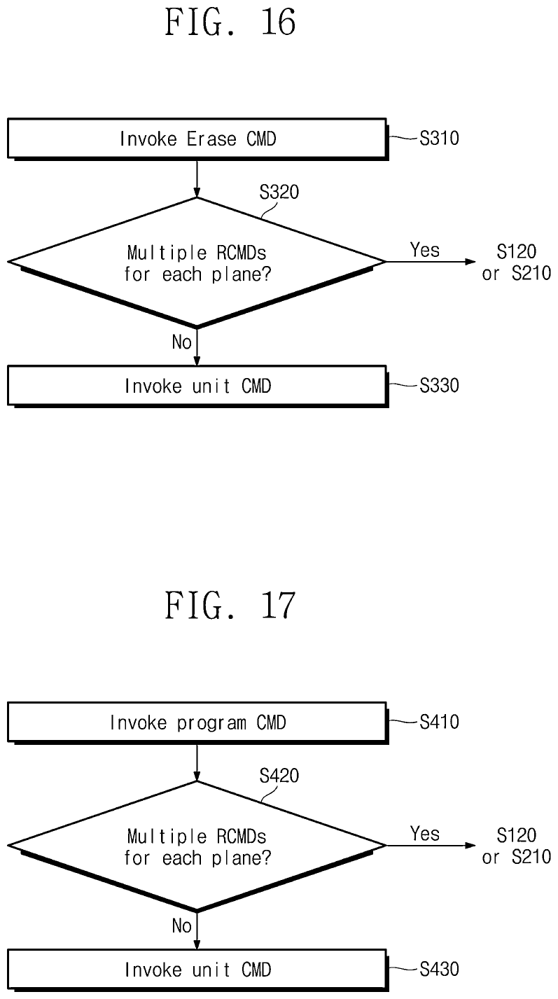

FIG. 16 is a diagram a flowchart illustrating a command processing operation method of a controller according to example embodiments.

Referring to FIG. 16, in operation S310, the controller may invoke an erase command to the nonvolatile memory. The nonvolatile memory may perform an erase operation in units of blocks, based on the received erase command.

In operation S320, the controller may determine whether there are a plurality of read commands for different pages of different planes. When there is no plurality of read commands, the flow proceeds to operation S330 in which the controller may invoke a unit command to the nonvolatile memory.

According to some embodiments, when there are the plurality of read commands, the controller may merge the read commands according to the above-described embodiments (S120) or determine whether there is a page of the same type (operation S210).

FIG. 17 is a flowchart illustrating a command processing operation method of a controller according to example embodiments.

Referring to FIG. 17, in operation S410, the controller may invoke a program command to the nonvolatile memory. The nonvolatile memory may perform a program operation in units of pages, based on the received program command.

In operation S420, the controller may determine whether there are a plurality of read commands for different pages of different planes. When there is no plurality of read commands, the flow proceeds to operation S430 in which the controller may invoke a unit command to the nonvolatile memory.

According to some embodiments, when there are the plurality of read commands, the controller may merge the read commands according to the above-described embodiments (S120) or determine whether there is a page of the same type (operation S210).

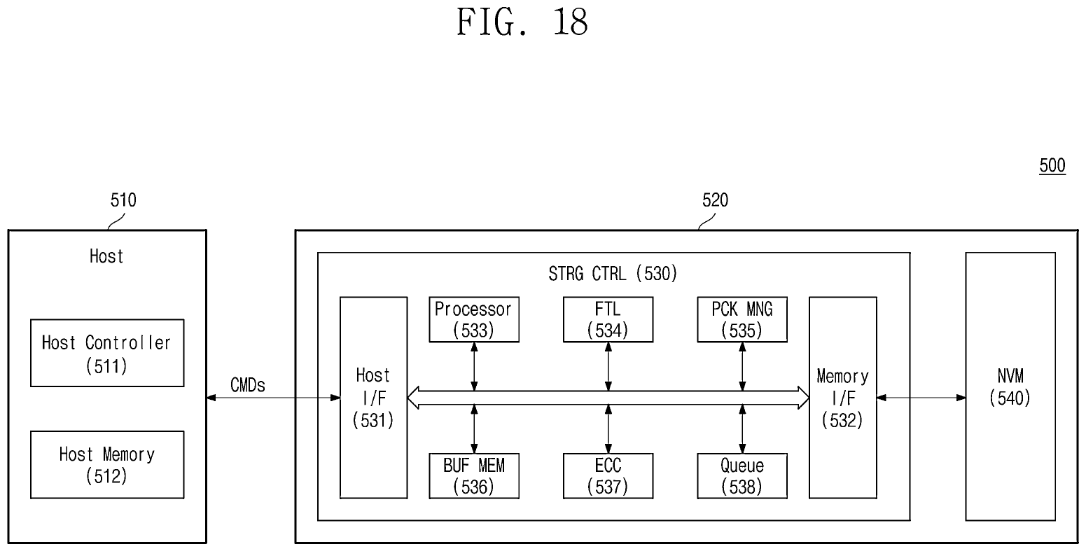

FIG. 18 is a diagram illustrating a storage system according to example embodiments.

Referring to FIG. 18, a storage system 500 according to example embodiments may include a host 510 and a storage device 520.

The host 510 may include a host controller 511 and a host memory 512. The host memory 512 may serve as a buffer memory 536 to temporarily store data to be transmitted to the storage device 520 or data transmitted from the storage device 520.

The host 510 may include, for example, a personal computer (PC), a laptop computer, a mobile phone, a smartphone, or a tablet PC. The host 510 may invoke a plurality of commands CMDs to the storage device 520 for a plurality of planes, each including a plurality of pages.

The storage device 520 may include a storage controller 530 and a nonvolatile memory 540.

According to example embodiments, the storage device 520 may be configured to receive a plurality of commands CMDs from the host 510, merge a plurality of read commands associated with at least two different pages among the plurality of commands CMDs, and perform a read operation based on a merge command signal.

The storage device 520 may include storage media storing data in response to a request from the host 510. For example, the storage device 520 may include at least one of a solid state drive (SSD), an embedded memory, and a removable external memory. When the storage device 520 is an SSD, the storage device 520 may be a device conforming to the nonvolatile memory express (NVMe) standard. When the storage device 520 is an embedded memory or an external memory, the storage device 520 may be a device conforming to the universal flash storage (UFS) or embedded multimedia card (eMMC) standard. Each of the host 510 and the storage device 520 may generate packets based on the adopted standard protocol and transmit the generated packets.

When the nonvolatile memory 540 of the storage device 520 includes a flash memory, the flash memory may include a 2D NAND memory array or a 3D (or vertical) NAND (VNAND) memory array. For example, the storage device 520 may also include other various types of nonvolatile memory. For example, the storage device 520 may employ a magnetic random access memory (MRAM), a spin-transfer torque MRAM, a conductive bridging RAM (CBRAM), a ferroelectric RAM (FeRAM), a phase RAM (PRAM), a resistive RAM, or other types of memory.

According to example embodiments, the host controller 511 and the host memory 512 may be implemented as additional semiconductor chips. In some embodiments, the host controller 511 and host memory 512 may be integrated into the same semiconductor chip. For example, the host controller 511 may be a module among a plurality of modules provided in an application processor, and the application processor may be implemented as a system-on-chip (SoC). In addition, the host memory 512 may be an embedded memory provided internally of the application processor, or may be a nonvolatile memory or a memory module disposed externally of the application processor.

The host controller 511 may manage an operation of storing data of a buffer region (for example, program data) in the nonvolatile memory 540 or storing data of the nonvolatile memory 540 (for example, read data) in the buffer region.

The storage controller 530 may include a host interface 531, a memory interface 532, a processor 533, a flash translation layer (FTL) 534, a packet manager 535, a buffer memory 536, an error correction circuit (ECC) 537, and a queue 538. The storage controller 530 may further include a working memory, not illustrated, to which the FTL 534 is loaded, and data program and read operations on the nonvolatile memory 540 may be controlled based on the processor 533 executing the FTL 534.

The host interface 531 may transmit and receive packets to and from the host 510. Packets transmitted from the host 510 to the host interface 531 may include a command (for example, the plurality of commands CMDs described above) or data to be programmed in the nonvolatile memory 540, and packets transmitted from the host interface 531 to the host 510 may include a response to a command or data read from the nonvolatile memory 540. According to example embodiments, a plurality of commands CMDs transmitted from the host interface 531 may include level adjustment information for adjusting a read voltage level for a read operation in each of a plurality of planes.

The memory interface 532 may transmit data to be programmed in the nonvolatile memory 540 to the nonvolatile memory 540 or receive data read from the nonvolatile memory 540. The memory interface 532 may be implemented to comply with a standard protocol such as Toggle or Open NAND Flash Interface (ONFI).

The processor 533 may perform data program and read operations on the nonvolatile memory 540. According to example embodiments, the processor 533 may be configured to perform the operations of the controller according to the above-described embodiments (for example, FIGS. 1 to 17). For example, the processor 533 may merge a plurality of read commands and invoke a merge command signal to the nonvolatile memory 540 through the memory interface 532.

The FTL 534 may perform various functions such as address mapping, wear-leveling, and garbage collection. The address mapping is an operation of converting a logical address, received from the host 510, into a physical address used to actually store data in the nonvolatile memory 540. The wear-leveling is a technique for preventing excessive deterioration of a specific block by allowing blocks in the nonvolatile memory 540 to be used evenly. For example, the wear-leveling may be implemented by firmware technology that balances erase counts of physical blocks. The garbage collection is a technique for securing usable capacity in the nonvolatile memory 540 by copying valid data of a block to a new block and then erasing an existing block.

The packet manager 535 may generate a packet based on a protocol of an interface negotiated with the host 510 or may parse various types of information from a packet received from the host 510. The buffer memory 536 may temporarily store data to be written in the nonvolatile memory 540 or data read from the nonvolatile memory 540. The buffer memory 536 may be configured to be included in the storage controller 530. In example embodiments, the buffer memory 536 may be disposed externally of the storage controller 530.

The ECC 537 may detect and correct errors in read data read from the nonvolatile memory 540. For example, the ECC 537 may generate parity bits for write data to be written in the nonvolatile memory 540, and the generated parity bits may be stored in the nonvolatile memory 540 along with the write data. When reading data from the nonvolatile memory 540, the ECC 537 may correct errors in the read data using the parity bits read from the nonvolatile memory 540 along with the read data, and may output the error-corrected read data.

The queue 538 may store a plurality of commands CMDs received from the host 510. The processor 533 may select a plurality of read commands from the queue 538, and may consecutively merge the plurality of read commands. Accordingly, the storage system according to the above-described embodiments may improve input/output efficiency and reduce power consumption through read operations for unaligned pages for each plane.

As set forth above, according to example embodiments, a storage device for performing a read operation on an unaligned page for each plane, a storage system including the same, and a method of operating the same may be provided.

While example embodiments have been shown and described above, it will be apparent to those skilled in the art that modifications and variations could be made without departing from the scope of the present inventive concept as defined by the appended claims.

As used herein, the terms “comprises”, “comprising”, “includes”, “including”, “has”, “having” and any other variations thereof specify the presence of the stated features, steps, operations, elements, components, and/or groups but do not preclude the presence or addition of one or more other features, steps, operations, elements, components, and/or groups thereof. In addition, it will be understood that, although the terms first, second, etc. may be used herein to describe various elements, these elements should not be limited by these terms. Rather, these terms are only used to distinguish one element from another. For example, a first element could be termed a second element, and, similarly, a second element could be termed a first element, without departing from the scope of the present disclosure.

What is claimed is:

1. A storage device comprising:
a nonvolatile memory comprising a plurality of planes, each comprising a plurality of pages; and
a controller configured to control the nonvolatile memory,
wherein the controller is configured to perform operations comprising:
receiving a plurality of commands from a host;
merging a plurality of read commands among the plurality of commands into a merge command signal, wherein the plurality of read commands are associated with at least two different planes among the plurality of planes and are associated with at least two different pages among the plurality of pages,
transmitting the merge command signal to the nonvolatile memory; and
applying the merge command signal to the nonvolatile memory.

2. The storage device of claim 1, wherein the controller is configured to transmit a single status check command for the at least two different planes, comprising the at least two different pages, to the nonvolatile memory after transmitting the merge command signal.

3. The storage device of claim 1, wherein the controller is configured to determine a number of the at least two different pages.

4. The storage device of claim 1, wherein each of the plurality of pages is classified as one of a plurality of logical pages corresponding to k-bits represented by a single memory cell,
wherein k is a positive integer greater than or equal to 2, and
wherein the controller is configured to merge the plurality of read commands into units of the plurality of logical pages.

5. The storage device of claim 4, wherein the controller is configured to merge the plurality of read commands into a same logical page, among the plurality of logical pages.

6. The storage device of claim 1, wherein the merge command signal comprises level adjustment information for adjusting a read voltage for a read operation for each of the plurality of planes.

7. The storage device of claim 6, wherein the level adjustment information comprises plane information for which the read voltage is to be adjusted.

8. The storage device of claim 1, wherein the nonvolatile memory is configured to perform a set-up on the at least two different pages based on receiving the merge command signal.

9. The storage device of claim 1, wherein the controller is configured to store the plurality of commands in a queue, select the plurality of read commands from the queue, and consecutively merge from the queue the plurality of read commands into the merge command signal.

10. The storage device of claim 1, wherein the controller is configured to adjust a read voltage for a read operation for each of the plurality of planes.

11. A method of operating a controller, the method comprising:
receiving a plurality of commands from a host;
merging a plurality of read commands among the plurality of commands into a merge command signal wherein the plurality of read commands are associated with at least two different planes among a plurality of planes, wherein the plurality of planes each comprise a plurality of pages and are each associated with at least two different pages among the plurality of pages; and
transmitting the merge command signal to a nonvolatile memory.

12. The method of claim 11, further comprising:
determining a number of the at least two different pages; and
merging a subset of the plurality of read commands corresponding to the number into the merge command signal.

13. The method of claim 11, further comprising:
transmitting a single status check command for the at least two different planes comprising the at least two different pages, to the nonvolatile memory.

14. The method of claim 11, wherein each of the plurality of pages is classified as one of a plurality of logical pages corresponding to k-bits represented by a single memory cell,
wherein k is a positive integer greater than or equal to 2, and
wherein the merging the plurality of read commands comprises merging the plurality of read commands into units of the plurality of logical pages.

15. The method of claim 11, wherein the merge command signal comprises level adjustment information for adjusting a read voltage for a read operation for each of the plurality of planes, and
wherein the level adjustment information comprises plane information for which the read voltage is to be adjusted.

16. The method of claim 11, further comprising:
storing the plurality of commands in a queue;
selecting the plurality of read commands from the queue; and
consecutively merging the plurality of read commands from the queue into the merge command signal.

17. The method of claim 11, further comprising:
adjusting a read voltage for a read operation for each of the plurality of planes.

18. A storage system comprising:
a host configured to apply a plurality of commands; and
a storage device configured to receive the plurality of commands from the host, merge a plurality of read commands among the plurality of commands into a merge command signal, wherein the plurality of read commands are associated with at least two different planes among a plurality of planes, wherein the plurality of planes each comprise a plurality of pages and are each associated with at least two different pages among the plurality of pages,
wherein the storage device is further configured to perform a read operation based on the merge command signal.

19. The storage system of claim 18, wherein the storage device comprises:
a nonvolatile memory comprising the plurality of planes; and
a storage controller configured to merge the plurality of read commands and transmit the merge command signal to the nonvolatile memory.

20. The storage system of claim 18, wherein the plurality of commands comprise level adjustment information for adjusting a read voltage for a read operation for each of the plurality of planes.
